(19) United States
(12) Patent Application Publication
(10) Pub. No.: US 2010/0279563 A1
(43) Pub. Date: Nov. 4, 2010

(54) Magnetic Fin Attachment System

(76) Inventors: Ian Godfrey Heard, (US); Kieron Edward Kobeike, (US)

Correspondence Address: Ian Godfrey Heard, 7, 79-83 Foamcrest Ave, Newport Beach, NSW, 2106, AU

(21) Appl. No.: 12/700,547

(22) Filed: Feb. 4, 2010

Related U.S. Application Data
(60) Provisional application No. 61/207,850, filed on Feb. 18, 2009.

(51) Int. Cl. B63B 1/00; H01F 7/02

(52) U.S. Cl. 441/79; 335/285

(57) ABSTRACT

Herein is disclosed a magnetic clamping system for attaching removable stabilizing fins or similar devices to any type of watercraft such as surfboards, wind-surfer craft, rowing sculls, water skis, sailboards and the like.

### CROSS-REFERENCE TO RELATED APPLICATIONS AND RELATED PATENTS

The present Utility patent application claims priority benefit of the U.S. provisional application for patent No. 61/207,850 filed on Feb. 18, 2009

The present Utility patent application references Australian Innovation Patent number 2009100060 titled ‘Magnetic Fin Attachment System’

### FIELD OF THE INVENTION

The invention pertains to methods of attaching removable fins and stabilizing devices to watercraft specifically such as surfboards but not excluding all and any type and size of floating watercraft.

### BACKGROUND OF THE INVENTION

Watercraft such as surfboards, windsurfing craft, rowing sculls, yachts and other craft are provided with fins or keels for the purposes of stabilisation and control. Removable fins have been a feature of such watercraft and particularly surf boards and rowing sculls in the past with a variety of mechanical attachment and removal methods. The removal of fins is a feature that enables the changing of fins to suit conditions or to simplify transport or storage. Until now attachment and removal systems, particularly in surfboards, have relied on slotted receptacles on the watercraft into which the fin or stabilizing device fits and is secured with mechanical locking devices or clips or screws. Screws are a common means of retention and security and which require an allen key or other device to unlock and remove. The disadvantages of such systems include stripping of screw threads, loss of keying devices and removed screws and length of time taken to remove or change fins or attachments. The advent of what is commonly known as rare earth magnet materials has enabled quantum steps in arts that employ magnets, such as clamping. The rare earths such as neodymium/boron/iron and somarium/cobalt are capable of producing magnetic field intensities many times greater than older ferrite and alnico materials. A method for magnetic attachment has previously been described in Australian Patent 2009100060 by Heard and Kobelke (Jan. 20, 2009). It has been subsequently and surprisingly found that a magnetic system comprising magnet elements each comprising an anisotropic neodymium/boron/iron or other rare earth magnet fixed between two parallel soft iron or steel pole plates and so arranged upon both the fin or stabilizing device and within its opposing receptacle on the watercraft that they attract and clamp to each other, and specifically where the pole plates on one magnet element are thicker than those on the opposite polarity other, provides stronger clamping force than one parallel pole magnet element within one member clamping to an iron or steel plate within the other member. The current invention describes the above magnetic fin or stabilizing device attachment system and also claims for variations of the parallel pole magnets in the form of circular or rectangular pot magnets and a magnetic element clamping only to a soft iron or steel plate.

### BRIEF DESCRIPTION OF THE DRAWINGS

The present invention is illustrated by way of example and not by way of limitation, in the figures of the accompanying drawings and in which like reference numerals refer to similar elements and in which:

FIG. 1 illustrates a magnet element as referenced in Claims 1, 2 and 3 where Item A is a preferably rectangular piece of unmagnetized anisotropic neodymium/boron/iron or other rare earth magnet material with internal particle alignment across its thickness B and sandwiched between two soft iron or steel pole plates, Items C and D. The pole plates are of preferably greater depth than the magnet material and preferably protrude beyond the lower extremity of the magnet material, such protrusion shown as Item E. Item F is a second and similar and opposite magnet element in which Item G is the magnet material and Items H and I are the soft iron or steel pole plates which are of greater thickness than those found on Item A. In each case the pole plates are preferably bonded to the magnet material with suitable fixative prior to a magnetizing procedure whch magnetizes the sandwiched unit as an assembly.

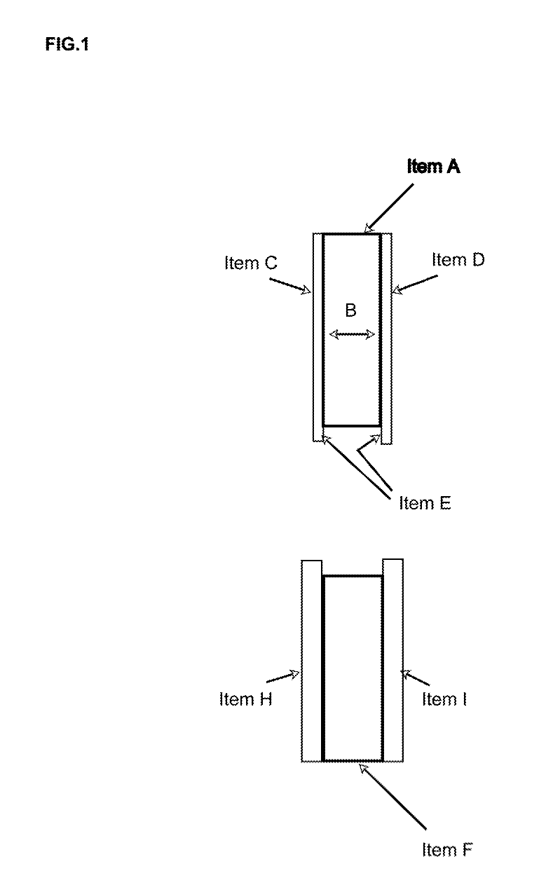

FIG. 2 shows the same assembled elements as those in FIG. 1 and their respective magnetic polarization after each has been magnetized as an assembly to have opposite polarity.

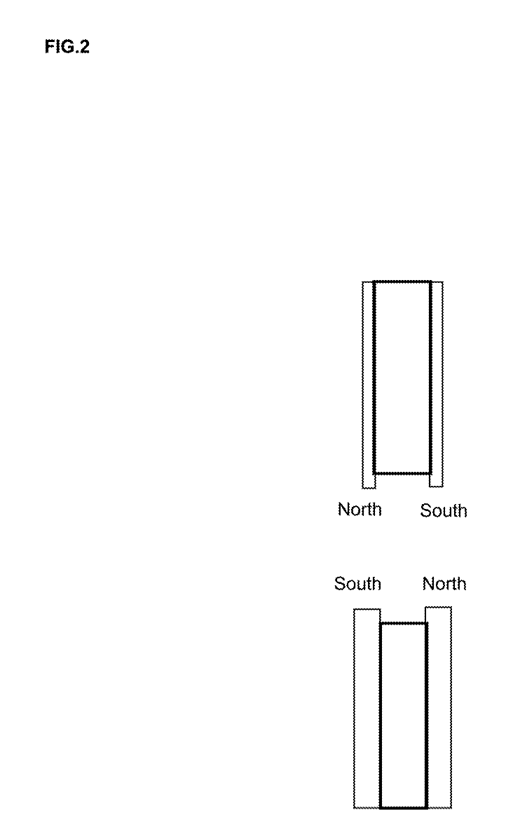

FIG. 3 illustrates the magnet elements described in FIGS. 1 and 2 forming part of a removable fin or stabilizing device and the receptacle for such fin or stabilizing device. Item J represents a cross-sectional view of the fin or stabilizing device with the magnet element or elements included and Item K is a cross-sectional view of the receptacle with magnet element or elements included. Items L and M represent a longitudinal cross-section of the fin or stabilizing device and its corresponding receptacle respectively, the stabilizing device sometimes but not always typically having portions shown as Item N removed in the interest of weight reduction. Item O is the parallel pole magnet element or elements with thicker pole plates within the receptacle and Item P is the magnet element or elements with thinner pole plates upon the fin or stabilizing device. In one embodiment the pole plates on the magnet element that is positioned on the fin or stabilizing device may form the outer surface of the fin for that portion of the fin that fits into the receptacle on the surfboard or watercraft as shown at Item Q.

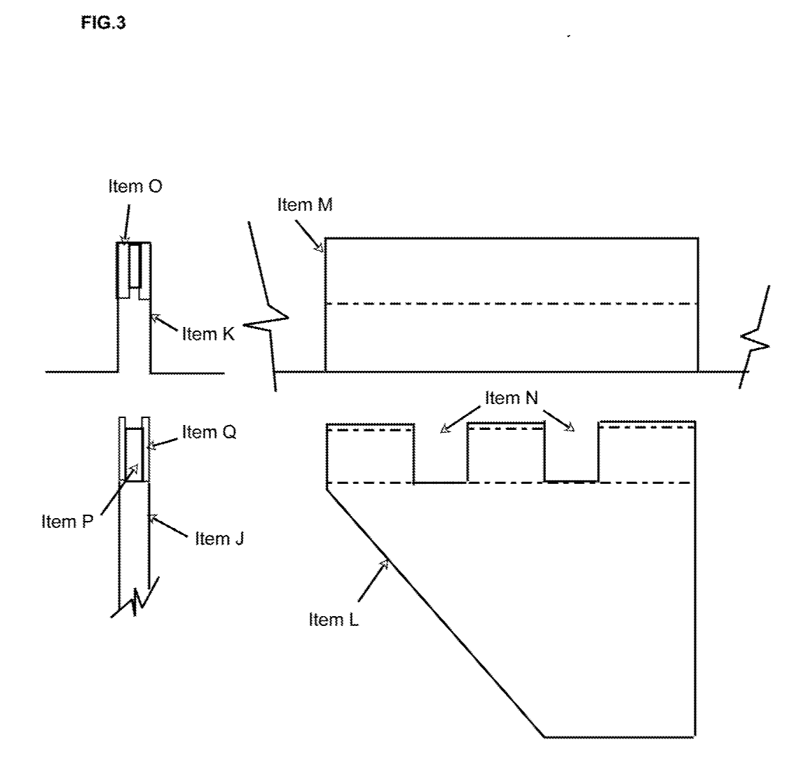

FIG. 4 shows an alternative embodiment using circular or rectangular neodymium/boron/iron magnet material within soft iron or steel cups. These are known as pot magnets to those familiar with magnetic art. Such pot magnets have a centre pole being North or South and an outer pole being opposite polarity. In FIG. 4 both a plan view and an elevation of each of the receptacle Item S and the fin or stabilizing device Item U is shown. A row of these pot magnets Item R forms the floor of the fin receptacle Item S and a corresponding row having opposite magnetic polarity and thicker iron or steel cups and shown as Item T is attached to the extremity of the fin or stabilizing device Item U so that the pot magnets within the receptacle engage with those on the fin when the fin is inserted in the receptacle.

FIG. 5 shows in cross section an alternative embodiment employing neodymium/boron/iron magnetizing components Item V within a soft iron or steel channel Item W and where the opposite elements, that is, the element housed within the receptacle and the element upon the fin have attracting magnetic polarities Item X and where the soft iron or steel of one element is thicker than that of its opposite and attracting element.

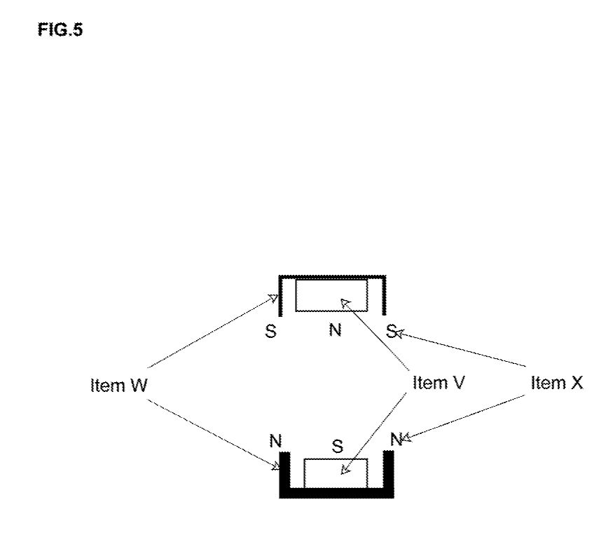

### SUMMARY OF THE INVENTION

To achieve the foregoing and other objects and in accordance with the purpose of the invention, a variety of techniques are herein described. It will be recognized by those familiar with the art that a number of mechanical methods exist for attaching removable fins or stabilizing devices to surfboards and other various types of watercraft. The method disclosed herein employs in a preferred embodiment, one or more parallel pole permanent magnet assemblies within or upon the fin or fins or other stabilizing devices as used on watercraft and one or more opposite magnetically polarized parallel pole permanent magnet assembly with thicker pole plates within or upon the watercraft itself, preferably within a fin housing such as those customarily used in such watercraft. The preferred embodiment could also have the at least one magnetic element with thicker pole plates within the fin and the other parallel pole at least one magnet element having thinner pole plates within the fin housing. Other embodiments may include at least one parallel pole permanent magnet assembly in either the fin or fins or the body of the watercraft and a steel or soft iron plate to respond to the said magnet assembly and within or upon the opposite member. Alternative embodiments may include at least one permanent magnetic assembly such as the neodymium/iron/boron magnet material within a soft iron or steel cup being round or rectangular in shape and known in magnetic art as pot magnets within one member and similar at least one assemblies of opposite polarity and having a greater wall thickness of the cup and within or upon the other member. The opposite polarity magnetic assemblies are so disposed and positioned on the fin or stabilizing device and within its receptacle on the watercraft that they magnetically attract and clamp together with great strength when the fin is inserted into the receptacle. In a further embodiment the at least one magnet elements within the fin receptacle and upon the fin consist of magnetizing components within soft iron or steel channels to produce three magnetic poles of opposite and attracting polarities. Of the said channels the at least one on either the fin or the receptacle comprises thicker soft iron or steel than the at least one opposite attracting channel and magnet assembly.

### DETAILED DESCRIPTION OF THE PREFERRED EMBODIMENTS

Watercraft such as those described above frequently feature removable fins or stabilizing devices and have one or more receptacles upon the underside of the craft itself, into which a fin or fins or stabilizing devices engage and are fixed with means other than a magnetic means. Such means include screws, clips and mechanical catches of a variety of types.

In a preferred embodiment of the current invention an un-magnetized rectangular block or blocks of neodymium/boron/iron anisotropic magnet material of suitable dimensions within the constraints of fins and fin receptacles is sandwiched between two soft iron or steel plates of suitable thickness and with said pole plates protruding somewhat beyond and below the depth of the unmagnetized magnet material block. The at least one assembly thus formed is preferably bonded together with suitable adhesive and then magnetised as an assembly in a magnetizer as used in the art. The at least one magnetized assembly is then attached to a surfboard or other watercraft fin in such a manner that the magnet assembly forms part of that portion of the fin that engages with the fin receptacle on the surfboard, rowing scull, windsurfing board or other watercraft and has the magnet assembly's active edges facing in the direction that will cause them to engage with similar but opposite polarity at least one magnet assemblies within and on the base of the fin receptacle on the watercraft.

In the invention, the at least one receptacles on the watercraft, also known as fin boxes to those familiar with the art, also features in the bottom of its open area an at least one magnetic assembly similar to that attached to the fin or fins but having opposite and attracting magnetic polarity. In a preferred embodiment the soft iron or steel pole plates of one of the magnetic assemblies will be thicker than those of the opposite polarity assembly. The magnetic assemblies will preferably be moulded respectively within both the one or more fins and the one or more fin receptacles to form an integral part of the one or more fins and the one or more fin receptacles. The magnet assembly forming part of the one or more fins should be no thicker nor any longer than the portion of the fin designed to reside within the receptacle. The magnetic assembly that forms part of the one or more receptacles will be dimensioned so as to fit within the constraints of the dimensions of the one or more receptacles and will form the floor of the receptacle.

In a preferred embodiment the magnet assemblies will be encased in a thin covering of resin or other suitable material to protect them from corrosion.

In an alternative embodiment the said soft iron or steel pole plates may be machined or otherwise manufactured to an ‘L’ shape or and inverted ‘T’ shape and applied to the rectangular neodymium/boron/iron block so as to provide a larger magnetic footprint at the attaching edge of the pole plates.

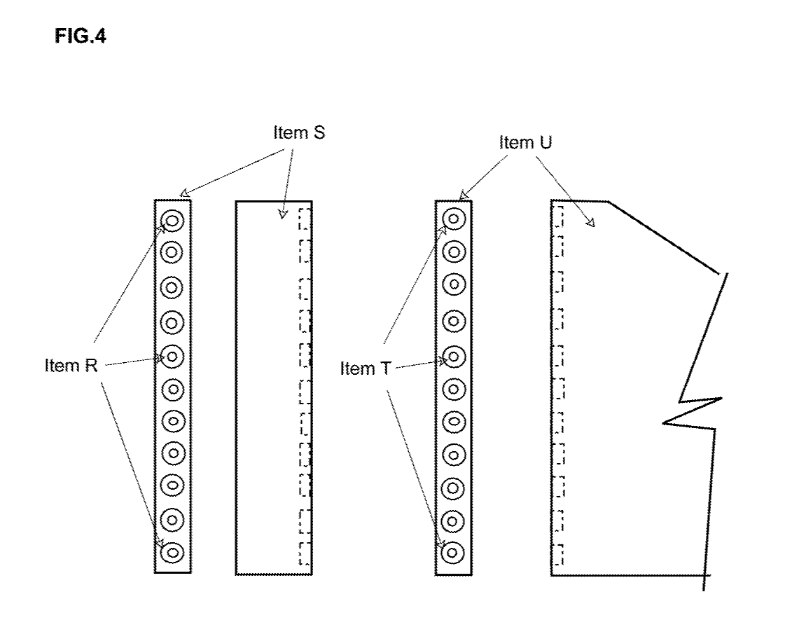

A further alternative embodiment illustrated in FIG. 4 may use what is known as pot magnets by those familiar with the art of magnetics. Such pot magnets are effectively parallel pole permanent magnets in circular or rectangular configuration and consist of a magnetizing element of neodymium/boron/iron or other rare earth magnet material in the form of a cylinder or cylindrical block or ring within a soft iron or steel housing in the form of a cup and positioned such that a magnetic air gap exists between the outer extremity of the cylinder and the inner wall of the cup. An embodiment using such pot magnets would feature a row of pot magnets within the fin receptacle and a row with opposing polarities and with thicker steel cups upon the fin or stabilizing device. Alternatively the thin-cupped pot magnets could be on the fin and thicker cupped pot magnets within the receptacle. Other embodiments for the magnet elements within the receptacle and upon the fin will include at least one soft iron or steel channel having rectangular or round neodymium/boron/iron or other rare earth magnets within the channel such magnets being of dimensions whose width allows a gap between it and the walls of the channel and whose height is less than the depth of the channel such channels providing a North/South/North magnetic field pattern across the face of the at least on magnet element within the fin box and providing a South/North/South magnetic field pattern across the face of the at least one magnet element upon the fin or vice versa such that the magnet elements on the fin and the receptacle attract each other. One or other of the said channels will be of thicker soft iron or steel than the other to which it is attracted.

What is claimed is:

1. A magnetic means of connecting a fin keel or centerboard to surfboards rowing sculls or any type of watercraft by means of at least one parallel pole permanent magnet element forming part of the fin on the one part and at least one parallel pole permanent magnet of opposite magnetic polarity forming part of the fin receptacle on the other part.

2. A magnetic means of connecting a fin keel or centerboard to surfboards or any watercraft by means of parallel pole permanent magnet elements as described in claim 1 where the parallel pole magnet elements on the fin and within the fin receptacle consist of neodymium iron boron or other rare earth magnet components sandwiched between pole plates of soft iron or steel.

3. A magnetic means of connecting a fin keel or centerboard to surfboards or any watercraft by means of parallel pole permanent magnet elements as described in claims 1 and 2 where the at least one parallel pole magnet elements on the fin and within the fin receptacle consist of neodymium iron boron or other rare earth magnet components sandwiched between pole plates of soft iron or steel and where the thickness of the pole plates on the at least one element on the fin or stabilizing device is of greater thickness than the pole plates on the opposite polarity at least one element within the receptacle.

4. A magnetic means of connecting a fin keel or centerboard to surfboards or any watercraft by means of parallel pole permanent magnet elements as described in claims 1 and 2 where the at least one parallel pole magnet elements on the fin and within the fin receptacle consist of neodymium iron boron or other rare earth magnet components sandwiched between pole plates of soft iron or steel and where the thickness of the pole plates on the at least one element within the receptacle is of greater thickness than the pole plates on the opposite polarity at least one element upon the fin or stabilizing device.

5. A magnetic means of connecting a fin keel or centerboard to surfboards or any watercraft by means of at least one permanent magnet element consisting of at least one pot type magnet assembly forming part of the fin or stabilizing device and at lest one permanent magnet element of the pot type magnet and of opposite and therefore attracting polarity forming part of the bottom of the receptacle on the surfboard or watercraft with either the at least one magnetic element on the fin or in the bottom of the receptacle having a thicker soft iron or steel cup than its magnetically opposite element on the fin or within the receptacle. Further the opposite polarity magnetic elements are disposed upon the fin and within the receptacle so as to engage with each other when the fin is inserted into the receptacle.

6. A magnetic means of connecting a fin keel or centerboard to surfboards or any watercraft by means of at least one permanent magnet elements within the fin receptacle on the watercraft and upon the fin or stabilizing device such magnet elements consisting of a soft iron or steel channel housing within its width and depth neodymium/boron/iron magnet material of rectangular or round shape such that a magnetic field is produced across the face of the channel having North-South-North magnetic fields configuration on the at least one magnet element on the fin and a South-North-South magnetic fields configuration on the at least one element on the watercraft fin receptacle with one of the soft iron or steel channels being of thicker steel than the other.

7. A magnetic means of connecting a fin keel or centerboard to surfboards or any watercraft by means of parallel pole or other permanent magnet elements as described in claims 1 to 6 where the at least one magnet elements for the fin and for within the fin receptacle are each assembled with their respective neodymium/boron/iron components being in an un-magnetized condition and in which the assembled at least one elements are each magnetized after assembly thereby to maximize magnetic strength within the assembled magnetic circuit.

8. A magnetic means of connecting a fin keel or centerboard to surfboards or any watercraft by means of at least one parallel pole permanent magnet element or of the pot magnet type or of the channel magnet type as described in claims 1 through 7 above forming part of the fin or the fin receptacle on the one part and a soft iron or steel attachment plate forming part of the fin or fin receptacle on the other.
